(19) United States
(12) Patent Application Publication
(10) Pub. No.: US 2011/0072945 A1
(43) Pub. Date: Mar. 31, 2011

(54) CUTTING UNIT

(76) Inventor: Bernd LOIBL, Klettgau (DE)

(21) Appl. No.: 12/904,496

(22) Filed: Oct. 14, 2010

Related U.S. Application Data
(63) Continuation of application No. 11/057,131, filed on Feb. 15, 2005.
Application No. 11/057,131 is a continuation-in-part of application No. 10/797,024, filed on Mar. 11, 2004, now abandoned.

(30) Foreign Application Priority Data
May 8, 2003 (DE) 203 07 241.4
Dec. 5, 2003 (DE) 203 19 003.3
Apr. 20, 2004 (EP) 04 009 250.4

(51) Int. Cl. B26D 1/09

(52) U.S. Cl. 83/471; 83/651

(57) ABSTRACT

A cutting unit for trimming sheet material is provided. The cutting unit includes a bed for supporting the sheet material, a guillotine cutting device including a knife arm pivotally mounted on the bed, and a rotary cutting device mounted on the bed. The rotary cutting device includes a guide bar, a knife carriage displaceable along the guide bar, and a circular knife rotatably mounted in the knife carriage. The knife arm and the rotary cutting device are mounted on opposite sides of the planar bed relative to one another and are operable to permit parallel trimming of opposite sides of the sheet material when the sheet material is supported on the planar bed. The guide bar selectively pivots toward and away from the bed against action of a spring to define a lower cutting position so that the cutting operation may be performed and an upper initial position whereby the guide bar pivots away from said bed for inserting paper for said cutting operation.

### CROSS-REFERENCE TO RELATED APPLICATIONS AND CLAIM TO PRIORITY

This is a continuation in part of application Ser. No. 10/797,024, filed Mar. 11, 2004, priority to which is claimed under 35 U.S.C. §120, the disclosure of which is incorporated herein by reference. This application is based upon application number 04 009 250.4, filed Apr. 20, 2004 in the European Patent Office, the disclosure of which is incorporated herein by reference and priority to which is claimed under 35 U.S.C. §119.

### FIELD OF THE INVENTION

The invention concerns a cutting unit for trimming sheet material such as paper, films or the like, having a planar bed for supporting the sheet material, which bed is equipped on one side with a guillotine cutting device that has a pivotably mounted knife arm having a blade held thereon and a counterknife held in stationary fashion on the bed.

### BACKGROUND OF THE INVENTION

Cutting units of the aforesaid kind are provided in particular for office use. They serve to trim paper sheet material, usually of DIN A4 format and smaller, at most DIN A3 format. The cutting units have a guillotine cutting device on one longitudinal side. A guillotine cutting device of this kind has a knife arm, mounted pivotably about a horizontal axis at one corner of the bed, on which a cutting knife, projecting on the lower side, is attached. It corresponds to a counterknife secured on the bed. Arranged at the free end of the knife arm is a handle with which the knife arm can be pivoted down from an upwardly pivoted position, with the consequence that a sheet material projecting beyond the counterknife is trimmed. Such cutting units have been used in offices for decades in essentially the same configuration.

Sheet material can be cut relatively well with such cutting units if the sheet material projects not inconsiderably beyond the counterknife, since otherwise the risk exists that the excess length will be pushed downward by the blade and not trimmed cleanly. A sheet stack comprising several sheets can also be cut simultaneously, provided the sheet stack's height is not too great.

Difficulties are encountered in producing a smooth cut edge if, in particular, there is only a small excess length beyond the counterknife. With guillotine cutting devices the risk also exists that the bearing assembly of the knife arm may acquire play over time, so that in order to produce a smooth cut it is necessary to press the knife arm with considerable pressure against the counterknife. Since this condition of the cutting unit is not detectable, unsatisfactory cutting results are obtained.

### SUMMARY OF THE INVENTION

It is the object of the invention to configure a cutting unit of the kind cited initially in such a way that good cutting results are obtained even under difficult conditions.

According to the present invention, this object is achieved in that there is provided, preferably on a different side of the bed, a rotary cutting device that has a knife carriage displaceable on a guide bar and a circular knife rotatably mounted therein. The basic idea of the invention is thus to make available a cutting unit having two different kinds of cutting device, the one cutting device having strengths in the area in which the other cutting device works less well. Whereas the guillotine cutting device is suitable in particular for trimming sheet stacks, the rotary cutting device according to the present invention is characterized by a clean cut even with minimal excess lengths or when cutting off margins. It can therefore be used particularly effectively for trimming the margins of photographic prints or the like. The cutting unit according to the present invention is thus substantially more versatile to use, and takes up no more space than known cutting units of the species.

In a development of the invention, provision is made for the guillotine and rotary cutting devices to be arranged so that they have cutting directions extending in parallel fashion. This creates the possibility of trimming sheet material on both sides simultaneously and in absolutely parallel fashion, in which context the spacing could be dimensioned in accordance with a specific standard format. There can also be provided, between the guillotine and rotary cutting devices, a stop bar that extends parallel to the cutting directions and is displaceably guided transversely to the cutting directions.

The circular knife advantageously has a rotation axis parallel to the bed. The circular knife should be in contact, or at least be pressable, with its blade against a counterknife bar that can be made, for example, of plastic.

According to a further feature of the invention, provision is made for the guide bar to be raisable from a lower cutting position into an upper initial position, and lowerable from the latter back into the cutting position; and for the gap between bed and guide bar to be inaccessible from the ends of the guide bar. The idea underlying this is to effect the vertical movement of the circular knife not by way of the knife carriage but by means of the guide bar, by first raising the guide bar in order to slide the sheet stock through and then lowering it into the cutting position in which the circular knife rests on the bed. This makes handling of the cutting operation substantially simpler, and results in clean cuts. It is particularly important in this context that the gap between guide bar and bed be inaccessible from the ends of the guide bar, i.e. be covered there, so that it is not possible for the operator's fingers to enter the gap in that region and get caught as the guide bar is lowered.

In a further embodiment of the invention, it is proposed that the guide bar be guided in vertically displaceable fashion in the region of its ends so that it can be raised and lowered parallel to the bed, preferably by no more than 20 mm, preferably approx. 12 mm. As an alternative to this, however, provision can also be made for the guide bar to be mounted pivotably about a horizontal axis in the region of one end, specifically through an angle of at most 10°, preferably 4 to 5°. In order for the gap between bed and guide bar to be inaccessible at the two ends of the guide bar, those ends should overlap the bed. It is understood that in the context of a pivotably mounted guide bar, this overlap is necessary only at the latter's free end and not in the region of the pivot bearing, since the pivot bearing itself already constitutes a barrier to access to the gap between bed and guide bar. If an overlap is provided, this can be done by way of a downwardly projecting protective tab overlapping the bed. To ensure good lateral guidance of the guide bar in this region, the protective tab should fit into a matching slot in the bed.

The guide bar can be suspended in such a way that without actuation, it assumes the cutting position in which the circular knife rests on the bed. The guide bar can be raised manually in order to slide the sheet material through the gap between guide bar and bed. As an alternative to this, however, the possibility also exists that without actuation, the guide bar is held in the initial position by means of a spring. This facilitates sliding of the sheet material through the gap, but requires that the guide bar be pushed down for the cutting operation. A clean cut is obtained with this embodiment as well, however, since the guide bar can be pushed down with one hand and the knife carriage displaced with the other hand; this is much simpler in terms of handling than with known rotary cutting devices, in which the knife carriage must be pushed down and simultaneously displaced.

Provision is further made according to the invention for the guide bar to be retainable in the cutting position at its vertically movable end(s) with an immobilization device or devices. The guide bar is thereby immobilized for the cutting operation and cannot move by itself, and need not be pushed down during the cutting operation if a spring is working against it. This simplifies operation of the cutting unit.

The or each immobilization device is preferably embodied as a snap device into which the guide bar automatically and disengageably snaps upon movement into the cutting position, so that immobilization of the guide bar in the cutting position is not associated with additional actions. All that is necessary for the disengagement operation after the cutting operation is an actuation of the snap device in order to disengage it. The snap device can have for that purpose an actuation slider that is mounted at an appropriate location.

In a further embodiment of the invention, it is proposed that the bed have a region having a flexible edge, preferably a cutting bed made of an elastomeric material, and that the guide bar with the knife carriage be associated movably with the cutting unit. The user thus has the ability to arrange and use the rotary cutting device differently within the region of the elastic cutting bed. The guide bar should, in this context, protrude above a support plate that is placeable on the cutting bed. The support plate is preferably made of a transparent plastic, and lines can be provided that extend parallel to the guide bar and permit alignment of the guide bar.

The invention further provides that the guillotine cutting device is exchangeable for the rotary cutting device and vice versa. The bed can, in this fashion, be equipped alternately with the cutting device that is especially suitable for that particular cutting operation. If, for example, a sheet material made up of several plies of paper or film is to be trimmed, the guillotine cutting device is joined to the bed. If individual photographs or the like are to be trimmed, the guillotine cutting device is replaced with the rotary cutting device, since it is particularly suitable therefor. The advantage of exchangeability as compared with a fixed arrangement of both cutting devices is the fact that the one cutting device does not interfere with placement of the sheet material when trimming with the other cutting device. This also makes it possible to keep the bed relatively short in the direction transverse to the longitudinal axis of the respective cutting device, and thus to make the cutting unit compact and thus also easy to transport.

Releasable joining between the bed and the respective cutting device can be accomplished in various ways. For example, the bed on the one hand and the guillotine cutting machine and rotary cutting machine on the other hand can comprise complementary holding elements with which either the guillotine cutting device or the rotary cutting device can be attached on one side of the bed. The holding elements should comprise detent devices that enable simple attachment and at the same time ensure that the respective cutting device is attached in the correct position. The detent devices can be embodied in such a way that they are self-locking upon attachment of the cutting device, but require a disengagement actuation upon removal. This ensures that the cutting device in question cannot release itself from the detent position.

Lastly, provision is made according to the invention for the bed to comprise an additional bed that can be pulled out and retracted transversely to the longitudinal axis of the guillotine or rotary cutting device. The bed can thereby be made substantially longer for trimming larger formats. For smaller formats and for transporting the cutting unit, the additional bed can be retracted into the main bed so that the cutting unit requires only a small amount of space.

### BRIEF DESCRIPTION OF THE DRAWINGS

The invention is illustrated in more detail, with reference to exemplary embodiments, in the drawings, in which:

FIG. 1 is an oblique view of the cutting unit according to the present invention;

FIG. 2 is a side view of the rotary cutting device of the cutting unit according to FIG. 1;

FIG. 3 is a cross section through the cutting unit according to FIGS. 1 and 2 in the region of the rotary cutting device;

FIG. 4 is an oblique view of a further exemplary embodiment of the cutting unit according to the present invention, before the cutting operation;

FIG. 5 is the oblique view according to FIG. 4, after the cutting operation;

FIG. 6 is an oblique view of a third embodiment of a cutting unit, restricted to the corner region having the free end of the guide bar;

FIG. 7 is an oblique view of a fourth exemplary embodiment of the cutting unit according to the present invention, with the rotary cutting device placed movably with respect to it;

FIG. 8 is the oblique view according to FIG. 6 with the rotary cutting device placed on the cutting unit;

FIG. 9 is an oblique view of a fifth exemplary embodiment of the cutting unit according to the present invention, with replaceable guillotine and rotary cutting devices; and

FIG. 10 is a cross section through the cutting unit according to FIG. 9, with the guillotine cutting device in place.

### DETAILED DESCRIPTION OF THE PREFERRED EMBODIMENT(S)

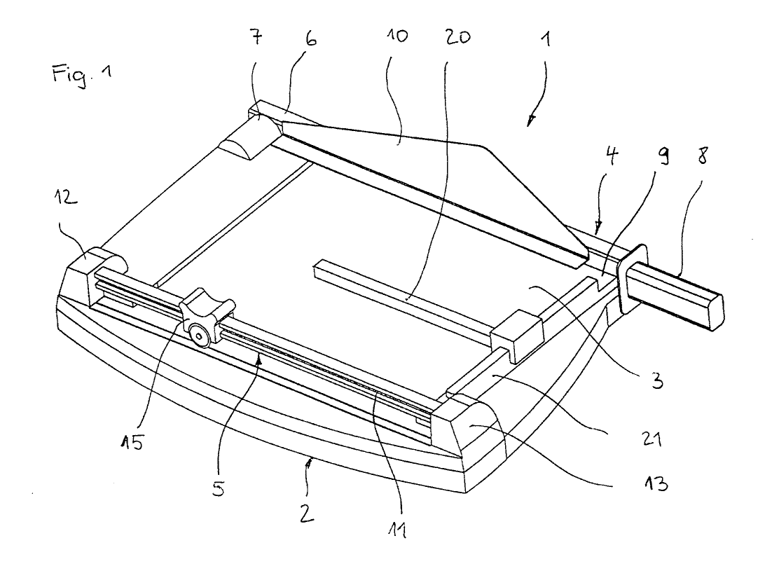

Cutting unit 1 depicted in FIG. 1 comprises a frame plate 2, substantially rectangular in plan, whose horizontal upper side forms a bed 3 for sheet material to be trimmed. A guillotine cutting device 4 is arranged on the upper (in this view) longitudinal side, and a rotary cutting device 5 on the lower (in this view) longitudinal side.

Guillotine cutting device 4 comprises a knife arm 6 that is mounted pivotably, in a bearing 7, about a horizontal axis extending transversely to the longitudinal side there. Knife arm 6 is equipped on its lower side, substantially over its entire length, with a cutting knife that is concealed in this view. Configured at the free end of knife arm 6 is a handle 8 with which knife arm 6 can be pivoted upward and downward. In the position shown, knife arm 6 is located in the lower terminal position.

The cutting knife of knife arm 6 corresponds to a counterknife 9 that is recessed flush into bed 3. Joined to knife arm 6 is a protective apparatus 10 that covers the cutting knife when knife arm 6 is raised, and thus offers protection for the operator.

Rotary cutting device 5 comprises a guide bar 11 that extends at a distance from bed 3 between two holding blocks 12, 13, parallel to the cutting edge and cutting direction of guillotine cutting device 4. A knife carriage 14 is guided on guide bar 11 displaceably in the direction of the longitudinal axis of guide bar 11, and can be slid manually back and forth.

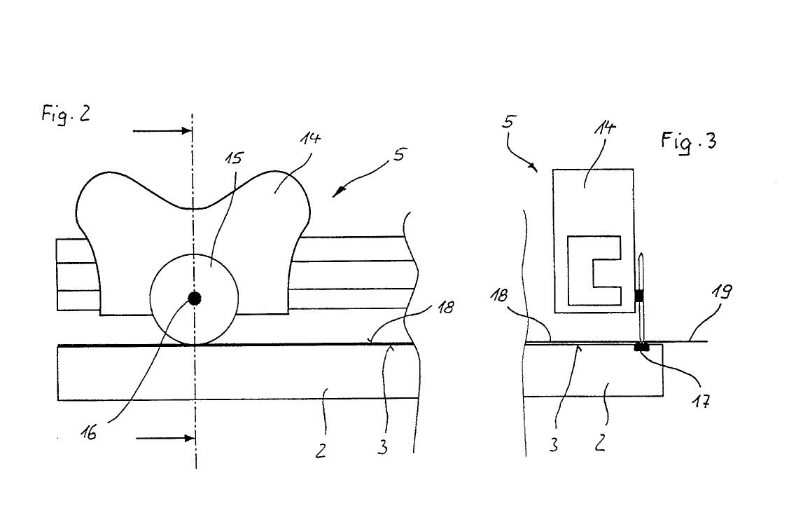

As shown in particular by FIGS. 2 and 3, a circular knife 15 is mounted rotatably on knife carriage 14, specifically about a horizontal axis 16 that extends transversely to the longitudinal axis of guide bar 11. Circular knife 15 projects downward beyond knife carriage 14 and makes contact against a counterknife bar 17 that is recessed into bed 3 and extends parallel to guide bar 11. In the example according to FIGS. 2 and 3, circular knife 15 is presently traveling over a sheet of paper 18 and cutting off its excess length 19 by displacement of knife carriage 14.

Extending between guillotine cutting device 4 and rotary cutting device 5, parallel to them, is a stop bar 20 against which sheet material can be aligned. Stop bar 20 encompasses at the end a guide bar 21, and is guided thereon in transversely displaceable fashion. Guide bar 21 extends at right angles to the cutting directions of guillotine cutting device 4 and rotary cutting device 5.

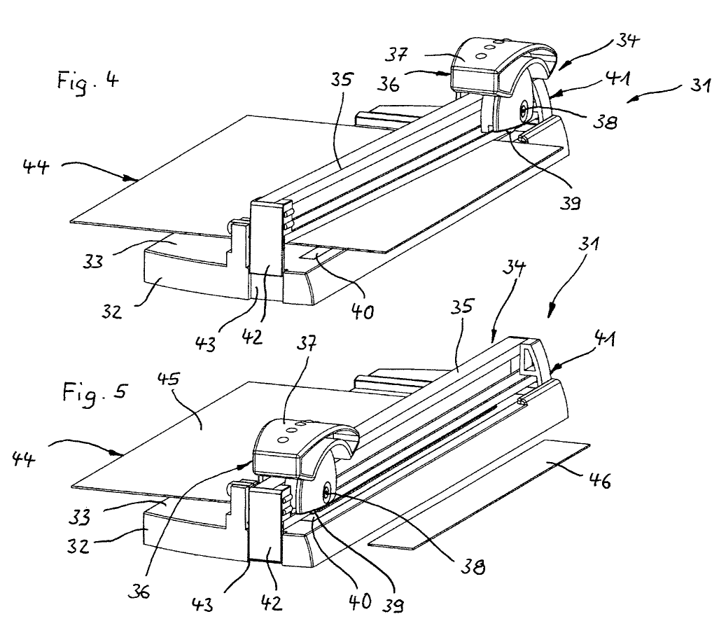

Cutting unit 31 depicted in FIGS. 4 and 5 comprises a frame plate 32, substantially rectangular in plan, whose horizontal upper side forms a bed 33 for sheet material to be trimmed. Located in the region of the front (in this view) longitudinal side of frame plate 32 is a rotary cutting device 34. The guillotine cutting device additionally present in the embodiment according to FIGS. 1 through 3 is not depicted here in further detail.

Rotary cutting device 34 comprises a guide bar 35 that extends, at a distance from bed 33, parallel to the longitudinal side of frame plate 32. A knife carriage 36 is guided, displaceably in the direction of the longitudinal axis of guide bar 35, on guide bar 35. It surrounds guide bar 35 in U-shaped fashion and has on the upper side an attachment 37 with which knife carriage 36 can be slid manually back and forth. Knife carriage 36 has, on the front (in this view) side, a bearing shaft 38 which extends horizontally and transversely with respect to the longitudinal axis of guide bar 35, and on which a circular knife 39 is mounted in freely rotatable fashion. Attached on bed 33 below circular knife 39 is a support surface 40 that is made of an elastomeric material. It extends over the entire movement range of circular knife 39.

Guide bar 35 is joined pivotably, at the end located remotely in the views, to frame plate 32 via a pivot bearing 41. The pivot axis extends horizontally and transversely to the longitudinal axis of guide bar 35. Access to the gap between guide bar 35 and bed 33 is blocked by pivot bearing 41 in the region of this end of guide bar 35. At the other end, guide bar 35 comprises a downwardly directed protective tab 42. The latter fits into a guide groove 43 that is shaped into the short longitudinal side of frame plate 32 in such a way that protective tab 42 is enclosed on both sides and laterally guided.

In FIG. 4, guide bar 35 is located in an upwardly pivoted initial position, so that circular knife 39 is raised away from support surface 40 and a sheet material 44 to be trimmed can be slid without impediment through the gap between guide bar 35 and bed 33. In this position, guide bar 35 is held by a spring arranged close to pivot bearing 41, knife carriage 36 being located adjacent to pivot bearing 41. In this position, the lower end of protective tab 42 is still located in guide groove 43 so that the gap between guide bar 35 and bed 33 is inaccessible from this end as well.

For the cutting operation, guide bar 35 is pivoted downward against the spring and then assumes the position depicted in FIG. 5, in which it extends substantially parallel to bed 33. In that context, circular knife 39 comes into contact against support surface 40. Knife carriage 36 is then displaced out of the position shown in FIG. 4 in the direction of the free end of guide bar 35 with slight pressure on support surface 40, in which context circular knife 39 performs a rotary movement and simultaneously cuts sheet material 44. Trimmed sheet material portion 45 resting on bed 33, and cut-off sheet material portion 46, remain behind.

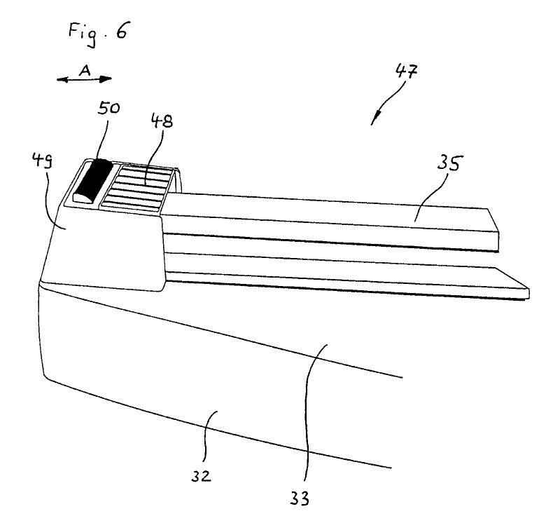

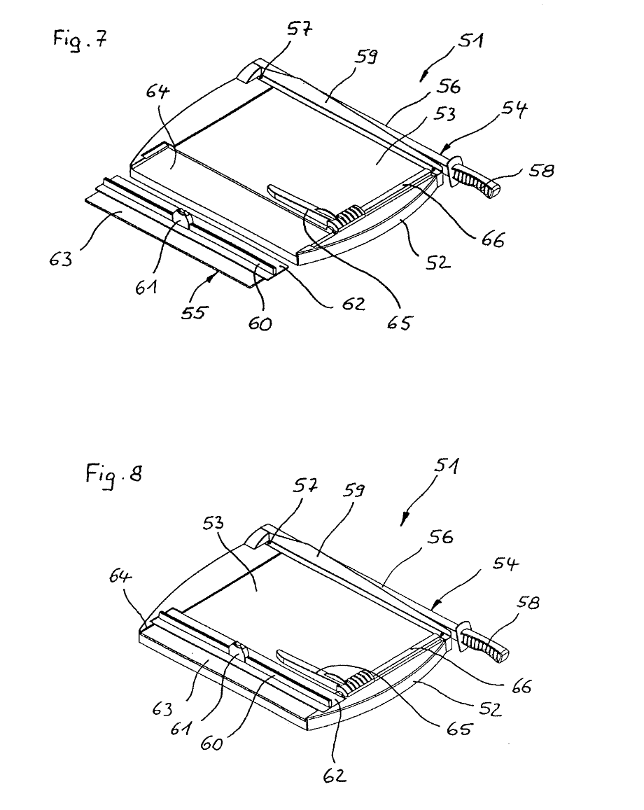

Cutting unit 47 depicted in FIG. 6 differs from cutting unit 31 only in the configuration of the region at the free end of guide bar 35; for identical or functionally identical parts, therefore, the reference numbers already used for FIGS. 4 and 5 are adopted for the description of this embodiment of cutting unit 47, and reference is made to the previous description. Only the differences will be presented below.

Instead of protective tab 42, guide bar 35 has at its free end a superimposed terminating block 48 that is enclosed on both sides by a guide block 49 embodied as a horizontal U and is thereby guided transversely to its longitudinal axis. Shaped into the end surface of terminating block 48 is a recess (not depicted in detail here) into which fits a catch guided in guide block 49. The catch is joined rigidly to an actuation slider 50 that is guided displaceably in the directions of double arrow A, actuation slider 50 being tensioned by a spring in the direction toward terminating block 48.

In the depiction shown, guide bar 35 is located in the (lower) cutting position and is held in that position by the catch, so that the cutting operation can be performed with no need to push guide bar 35 down. After the cutting operation, actuation slider 50 is displaced to the left, i.e. away from terminating block 48, so that the catch moves out of the recess in the end surface of terminating block 48 and guide bar 35 is released. The latter then pivots automatically, because of the action of the spring, into the upper initial position. For another cutting operation, guide bar 35 is once again pivoted toward bed 33. When the cutting position is reached, the catch snaps into the recess in terminating block 48 and thus once again retains guide bar 35.

Cutting unit 51 depicted in FIGS. 7 and 8 likewise comprises a frame plate 52, substantially rectangular in cross section, whose horizontal upper side forms a bed 53 for sheet material to be trimmed. A guillotine cutting device 54 is provided on an upper (in this view) longitudinal side, and a rotary cutting device 55 in the region of the lower (in this view) longitudinal side.

Guillotine cutting device 54 comprises a knife arm 56 that is mounted pivotably, in a bearing 57, about a horizontal axis extending transversely to the longitudinal side there. Knife arm 56 is equipped on its lower side, substantially over its entire length, with a cutting knife that is concealed in this view. Configured at the free end of knife arm 56 is a handle 58 with which knife arm 56 can be pivoted upward and downward. In the position shown, knife arm 56 is located in the lower terminal position.

The cutting knife of knife arm 56 corresponds to a counterknife, also not visible here, that is recessed flush into bed 53. Joined to knife arm 56 is a protective apparatus 59 that covers the cutting knife when the knife arm is raised, and thus offers protection for the operator.

Rotary cutting device 55 comprises a guide bar 60 on which a knife carriage 61 is guided displaceably in the direction of the longitudinal axis of guide bar 60. It can be slid manually back and forth. A circular knife (not depicted here in detail) is mounted rotatably on knife carriage 61, specifically about a horizontal axis that extends transversely to the longitudinal axis of guide bar 60. The circular knife projects downward beyond knife carriage 61. Guide bar 60 is attached on a support plate 62. Support plate 62, and guide bar 60 with knife carriage 61, are movable parts that can be placed at the very bottom onto bed 53 with support plate 62, as is apparent from FIG. 2.

Also belonging to rotary cutting device 55 is a cutting bed 63 that, for use, can be inserted into a recess 64 in bed 53, as is likewise apparent from FIG. 2. Cutting bed 63, made of an elastomer, terminates flush with the upper surface of bed 53. Cutting bed 63 acts as a counterknife for the circular knife.

In order for rotary cutting device 55 to be used, the unit comprising guide bar 60, knife carriage 61, support plate 62, and cutting bed 63 is placed in the position shown in FIG. 8. The unit comprising guide bar 60, knife carriage 61, and support plate 62 on cutting bed 63 can be displaced by hand to allow the cut to be performed at the intended point on the sheet material.

Extending between guillotine cutting device 54 and rotary cutting device 55, parallel to them, is a stop bar 65 against which sheet material can be aligned. Stop bar 65 encompasses at the end a guide bar 66, and is guided thereon in transversely displaceable fashion. Guide bar 66 extends at right angles to the cutting directions of guillotine cutting device 54 and rotary cutting device 55.

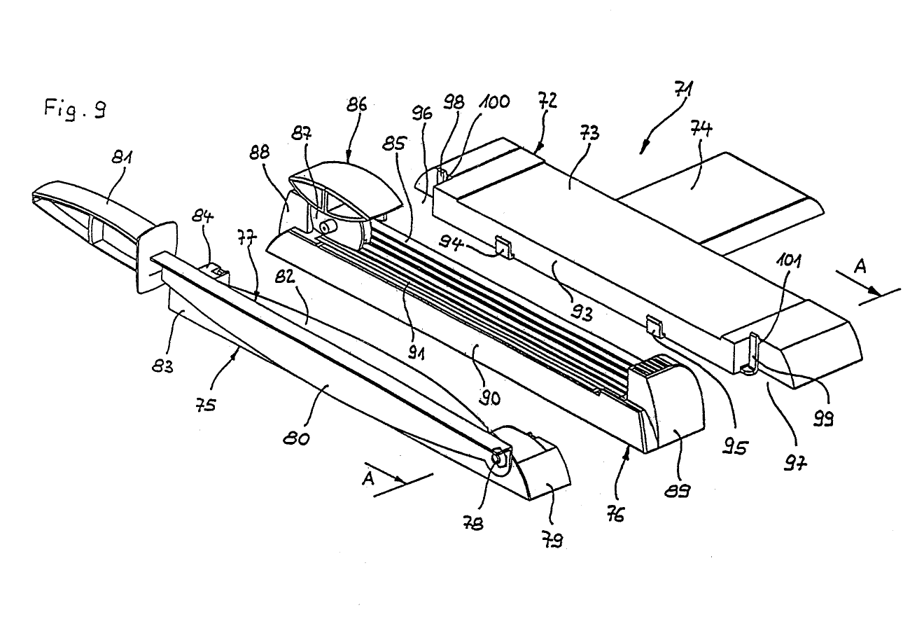

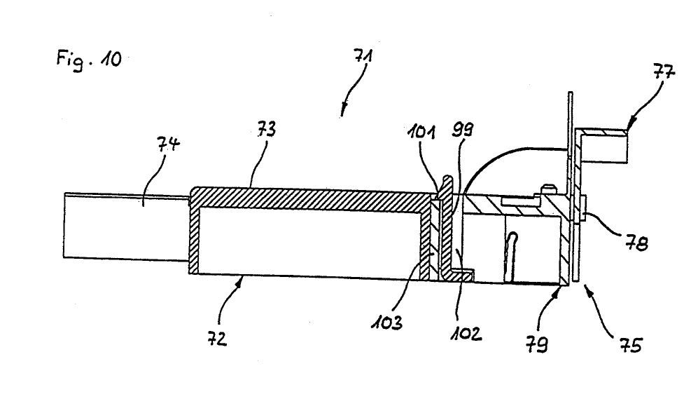

Cutting unit 71 depicted in FIGS. 9 and 10 comprises a frame plate 72, substantially rectangular in plan, whose horizontal upper side constitutes a bed 73 for sheet material to be trimmed. Bed 73 is supplemented with an additional bed 74 that is depicted in FIG. 9 in the pulled-out state. It is intended, when larger sheet material is being trimmed, to make available a larger bed for the sheet material. For trimming smaller formats and for transporting cutting unit 71, additional bed 74 is slid into a slot below bed 73. Bed 73 itself can thus, as illustrated, be relatively narrow.

A guillotine cutting device 75 and a rotary cutting device 76 are associated with bed 73. They are embodied as parts separate from bed 73 that can be alternately joined to bed 73 in a manner described in detail below. Guillotine cutting device 75 comprises a knife arm 77 that is supported in a bearing 78, pivotably about a horizontal axis, in a bearing block 79. Knife arm 77 is equipped on its underside, substantially over its entire length, with a cutting knife 80. Configured at the free end of knife arm 77 is a handle 81 with which knife arm 77 can be pivoted upward and downward. Joined to knife arm 77 is a protective apparatus 82 that covers cutting knife 80 when knife arm 77 is raised, and thus offers protection for the operator.

Bearing block 79 is joined rigidly, via a bridge support 83 extending parallel to knife arm 77, to a retainer 84 arranged close to handle 81. A detent device (not depicted here in detail), which prevents pivoting of knife arm 77 with respect to bridge support 82 while guillotine cutting device 75 is being handled, can be provided between retainer 84 and knife arm 77.

Rotary cutting device 76 comprises a guide bar 85 on which a knife carriage 86 is guided displaceably in the direction of the longitudinal axis of guide bar 85. It can be slid manually back and forth. A circular knife (here concealed by a knife housing 87) is mounted on knife carriage 71 rotatably about a horizontal axis extending transversely to the longitudinal axis of guide bar 85. The circular knife projects downward beyond knife housing 87. As in the exemplary embodiment according to FIGS. 4 and 6, guide bar 85 is mounted on a bearing block 88 pivotably about an axis extending parallel to the knife axis. At the other end, guide bar 85 fits into a terminating block 78 [sic: ?89] that is identical in design to terminating block 48 of cutting unit 47 depicted in FIG. 6, to the description of which reference is made. Bearing block 88 and terminating block 89 are connected via a longitudinal support 90 whose upper side comprises a cutting bed 91 for the circular knife.

Frame plate 72 has an end surface 93 that is provided for the attachment of either guillotine cutting device 75 or rotary cutting device 76. Mounted on end surface 93 are two hook-shaped holding elements 94, 95 that, with end surface 93, form grooves open at the top. Guillotine cutting device 75 and rotary cutting device 76 comprise retaining bars, complementary thereto, that fit into the grooves upon attachment of guillotine cutting device 75 or rotary cutting device 76. For that purpose, guillotine cutting device 75 or rotary cutting device 76 is placed against end surface 93 from above, and then lowered.

End surface 93 is set back at its ends so that recesses 96, 97 are formed there in frame plate 72. Bearing block 79 and retainer 84 of guillotine cutting device 75, on the one hand, and bearing block 88 and terminating block 89 of rotary cutting device 76, on the other hand, fit into recesses 96, 97. They each project in such a way that they fit into recesses 96, 97 when guillotine cutting device 75 or rotary cutting device 76 is in contact against end surface 93 and fitted into holding elements 94, 96.

Detent flanges 98, 99 protrude upward in recesses 96, 97. Detent flanges 98, 99 are fastened to frame plate 92 and are spaced laterally and frontally away from the walls of frame plate 72. At their upper ends, detent flanges 98, 99 form detent lugs 100, 101.

FIG. 10 is a section through cutting unit 71 in plane A-A of FIG. 9, showing guillotine cutting device 75 placed onto frame plate 72. Bearing block 79 comprises a slot 102, open at the bottom and top, that is delimited by a retaining strip 103 that is mounted on bearing block 79 and rests against the walls of recesses 97. Retaining strip 103 is overlapped at the top by detent lug 101 of detent flange 99, so that bearing block 79 is securely retained in recess 97 by detent flange 99. A corresponding configuration is provided in retainer 84 in terms of recess 96 and detent flange 98 therein, so that guillotine cutting device 75 is securely and nondisplaceably retained there as well. It is understood that bearing block 88 and terminating block 89 of rotary cutting device 76 are embodied in identical fashion on the side facing toward frame plate 72, so that rotary cutting device 76 is retained in the same fashion when exchanged with guillotine cutting device 75.

Insertion of retaining strip 103 into the gap between detent flange 99 and the oppositely located wall of recess 97 is accomplished by vertically downward motion from above. In this context, detent flange 99 is bent away from the oppositely located wall of recess 97 until detent lug 101 snaps over retaining strip 103. To remove guillotine cutting device 75 from frame plate 72, detent flanges 98 are bent away manually until retaining strips 103 can slide past detent lugs 100, 101, and guillotine cutting device 75 can thus be moved vertically upward and removed from frame plate 72. Rotary cutting device 76 can then be placed onto frame plate 72 from above, snap-locking with detent flanges 98, 99.

1-29. (canceled)

30. A cutting unit (1, 31, 47, 51) for trimming sheet material (18, 44) such as paper or films, comprising a planar bed (3, 33, 53) for supporting the sheet material (18, 44), which bed is equipped on one side with a guillotine cutting device (4, 54) that has a pivotably mounted knife arm (6, 56) having a blade held thereon and a counterknife (9) held in stationary fashion on the bed (3, 33, 53),
wherein there is additionally provided a rotary cutting device (5, 35, 55) that has a knife carriage (14, 36, 61) displaceable on a guide bar (11, 35, 60) and a circular knife (15, 39) rotatably mounted in said knife carriage (14, 26, 61), said circular knife (15, 39) having a rotational axis extending perpendicular to a longitudinal axis of said guide bar (11, 35, 60), and said guillotine cutting device (4, 54) and the rotary cutting device (5, 35, 55) are arranged so that they have cutting directions extending in parallel fashion, and
wherein said guide bar (11, 35, 60) of said rotary cutting device is adapted to selectively pivot toward and away from said bed against action of a spring to define a lower cutting position so that the cutting operation may be performed and an upper initial position whereby the guide bar pivots away from said bed for inserting paper for said cutting operation.

31. The cutting unit as defined in claim 30, wherein the rotary cutting device (5, 35, 55) is arranged on a different side of the bed (3, 33, 53).

32. The cutting unit as defined in claim 30, wherein there is provided, between the guillotine cutting device (4, 54) and rotary cutting device (5, 35, 55), a stop bar (20, 65) that extends parallel to the cutting directions and is displaceably guided transversely to the cutting directions.

33. The cutting unit as defined in claim 30, wherein the circular knife (15, 39) has a rotation axis parallel to the bed (3, 33, 53).

34. The cutting unit as defined in claim 30, wherein the circular knife (15, 39) is in contact or is pressable with its blade against a counterknife bar (17, 40, 63).

35. The cutting unit as defined in claim 30, further comprising a pivot bearing (41) pivotable joining said guide bar to said bed to thereby define a pivot axis that extends horizontally and transversely to the longitudinal axis of said guide bar.

36. The cutting unit as defined in claim 30, further comprising a catch to hold the guide bar in the lower cutting position against the action of said spring to positively hold an end of said guide bar in said power cutting position.

37. The cutting unit as defined in claim 30, wherein said catch is affixed to an actuation slider that is spring-baised to hold the guide bar in the lower cutting position.

38. The cutting unit as defined in claim 1, further comprising an elastomeric material extending along an entire movement range of said circular knife (15, 39).

39. The cutting unit as defined in claim 1, further comprising protective tab (42) so that a gap between the guide bar and the bed is inaccessible from an end of said guide bar when said guide bar is raised to said upper initial position.
